(19) United States
(12) Patent Application Publication
(10) Pub. No.: US 2014/0088760 A1
(43) Pub. Date: Mar. 27, 2014

(54) COMPUTER CONNECTED CASH DRAWER STATUS AND CONTROL

(71) Applicant: HEWLETT-PACKARD DEVELOPMENT COMPANY, L.P., Houston, TX (US)

(72) Inventors: Binh T. Truong, Houston, TX (US); Nam Nguyen, Houston, TX (US); Larry W. Kunkel, Houston, TX (US)

(73) Assignee: HEWLETT-PACKARD DEVELOPMENT COMPANY, L.P., Houston, TX (US)

(21) Appl. No.: 13/626,058

(22) Filed: Sep. 25, 2012

(51) Int. Cl. G06F 17/00; G07G 1/12

(52) U.S. Cl. 700/244; 312/237

(57) ABSTRACT

A computer monitors a connected state of a cash drawer and the open/closed status of one or more trays by way of circuitry and a BIOS program code. The computer opens the respective trays of the cash drawer by way of the circuitry and the BIOS program code. Alert messaging or alarm functions can also be performed in accordance with the monitoring. Cash drawer security, management and user convenience are improved accordingly.

### BACKGROUND

Cash handling and related point-of-sale apparatus are now commonly computer controlled. A cash drawer is coupled to a computer and user access is regulated by corresponding functions of the computer. The present teachings address the foregoing and related concerns.

### BRIEF DESCRIPTION OF THE DRAWINGS

The present embodiments will now be described, by way of example, with reference to the accompanying drawings, in which:

FIG. 1 depicts a block diagram of a computer-based cash drawer system according to one example of the present teachings;

FIG. 2 depicts an arrangement of a cash drawer and a portion of a computer according to another example;

FIG. 3 depicts a BIOS according to another example;

FIG. 4 depicts a flow diagram of a computer-based method according to another example;

### DETAILED DESCRIPTION

### Introduction

A computer monitors a connected state of a cash drawer and the opened-or-closed status of one or more trays by way of circuitry and a BIOS program code. The computer opens the respective trays of the cash drawer by way of the circuitry and the BIOS program code. Alert messaging or alarm functions can also be performed in accordance with the monitoring. Cash drawer security and other usage aspects are improved accordingly.

In one example, a system including a computer, the computer including circuitry to receive status signals corresponding to respective conditions of a cash drawer coupled to the computer. The circuitry configured to provide a control signal for opening a tray of the cash drawer. The computer also includes a solid-state storage media including a computer code defining a basic input-output system (BIOS). The BIOS is also configured to cause the computer to monitor conditions of the cash drawer by way of the status signals.

In another example, a cash drawer includes a tray to support at least currency, and a locking mechanism to open the tray in response to an electrical pulse. The cash drawer also includes a status switch to provide a signal corresponding to an open or closed state of the tray. The cash drawer further includes cabling to electrically couple the cash drawer to a computer by way of a connector.

In still another example, a computer-readable storage media including a program code defining a basic input-output system (BIOS) for a computer. The BIOS is configured to cause the computer to monitor a connected state of a cash drawer to the computer and to perform a first action accordingly. The BIOS is also configured to cause the computer to monitor an open state of a tray of the cash drawer and to perform a second action accordingly.

### Illustrative System

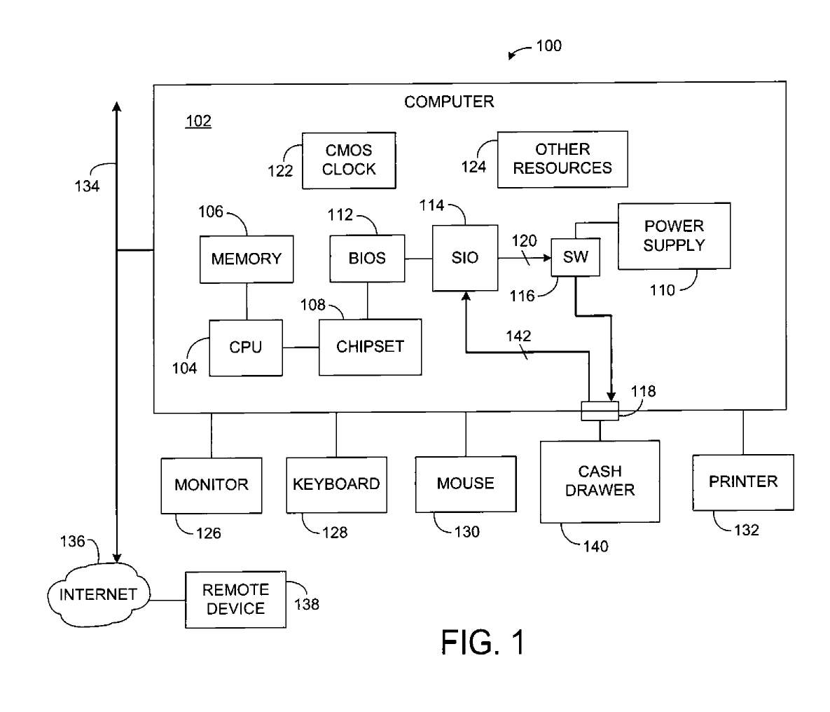

Attention is now turned to FIG. 1, which depicts a system 100 according to the present teachings. The system 100 is illustrative and non-limiting with respect to the present teachings. Other systems, devices, assemblies and arrangements can also be defined and used.

The system 100 includes a computer 102. The computer 102 includes a central processing unit (processor, or CPU) 104. The processor 104 is configured to perform various operations in accordance with a machine-readable program code. The computer 102 also includes a memory 106. The memory 106 can be defined by any machine-accessible solid-state storage configured to store and retrieve data, program code, and the like. The memory 106 is coupled in signal communication with the processor 104.

The computer 102 also includes a chipset 108. The chipset 108 can be variously defined and can include any suitable electronics, application specific integrated circuits (ASICs), communications-related devices and the like configured to cooperate with (i.e., communicate and/or be controlled by) the processor 104. The computer 102 also includes a power supply 110 configured to provide conditioned, regulated electrical power at one or more voltages. The power supply 110 is configured to provide electrical energy to the processor 104 and other elements of the computer 102.

The computer 102 also includes a machine-readable program code defining a basic input-output system (BIOS) 112, which is embodied within a computer-accessible storage media. In one example, the BIOS 112 is stored within an electrically erasable programmable read-only memory (EEPROM). In other example, the BIOS 112 is stored within FLASH memory. Other suitable storage media can also be used to store the BIOS 112.

The BIOS 112 includes program code configured to cause the processor 104 (i.e., the computer 102) to start-up and initiate operations, commonly referred to as “booting up”. The BIOS 112 further includes program code defining various utilities and functions for monitoring and controlling operation of a cash drawer, which the processor 104 is alerted to (i.e., flagged, or made aware of) during the start-up process. Such functions and utilities will be described in further detail hereinafter.

The computer 102 includes serial input-output (S10) 114 circuitry (or device) configured to couple the BIOS 112 in controlling relationship with a switching element (or elements) 116 and other circuitry (described below) of the computer 102. The computer 102 also includes the switching element(s) 116 introduced immediately above. Each switching element 116 can be defined by a transistor, relay, or other suitable element configured to selectively couple an electrical voltage with a respective node of a connector 118, in accordance with signaling 120 received from the SIO 114.

The computer 102 also includes a solid-state or CMOS clock (clock) 122. The clock 122 is defined by a dedicated-purpose circuit configured to keep time-of-day and date information after being set in accordance with user input. The clock 122 can be initially set (or thereafter reset) to a desired date and time in accordance with an access-controlled protocol. That is, the clock 122 can be set or reset only under user password input, electronic key usage, or another secured process that is resistant or invulnerable to unauthorized access. Other suitable clocks or access protocols can also be used.

The computer 102 further includes other resources 124. Such other resources can include, without limitation, wireless communications circuitry, network communications resources, solid-state data storage, magnetic or optical data storage, video or audio signal processing circuitry, circuitry related to control and monitoring of a cash drawer, and so on. Other resources can also be included or used. One having ordinary skill in the computer or related arts will appreciate many such other resources, and further elaboration is not germane to the present teachings except as elaborated below.

The system 100 also includes a monitor (or display) 126, a keyboard 128, a mouse 130 and a printer 132, each coupled to the computer 102. Each of the respective peripherals 126-132 can be variously defined and is configured to cooperate with the computer 102 as is familiar to one having ordinary skill in the art. The system 100 also includes a network 134 coupled in data or signal communication with the computer 102. The network 134 can be defined by a local-area network (LAN), a wide-area network (WAN) or other suitable network of peripherals or computers. The network 134 is coupled to the Internet 136, such that a remote device 138 can communicate with the computer 102.

The system 100 also includes a cash drawer 140 coupled to the computer 102 by way of the connector 118. The cash drawer 140 includes one or more trays, each configured to support paper currency, coins, negotiable paper or other things of value within a box or safe-like structure. The cash drawer 140 includes an electrically-actuated locking mechanism that functions to open a corresponding tray. The tray or trays of the cash drawer 140 is/are opened by voltage signaling sent from the computer 102 by way of the connector 118.

In one example, the cash drawer 140 opens a corresponding tray in response to a twenty-four volt pulse received from the computer 102. Other configurations or signal levels can also be used. In at least one example, the cash drawer 140 does not include a manually actuated key-type locking mechanism and is controlled (opened) exclusively by electrical signaling.

Normal, typical operations of the system 100 are generally as follows: The processor 104 starts up operations in accordance with machine-readable program code of the BIOS 112. The BIOS 112 also flags the processor 104 to the presence of program code directed to cash drawer control and monitoring during the start up process. Thereafter, the processor is referred to other program code stored within the memory 106, within disk storage of the other resources 124, and so on.

Status signals 142 are received from the cash drawer 140 at the SIO 114 by way of the connector 118. The status signals 142 can include or correspond to a connected state of the cash drawer 140 to the computer 102. The status signals 142 can also include or correspond to an open or closed state of each respective tray of the cash drawer 140. Other suitable status signals 142 can also be used.

In turn, the BIOS 112 includes program code configured to cause the computer 102 to monitor the connected state of the cash drawer 140 and the open/closed state of the corresponding tray(s) by way of digital communication with the SIO 114. The BIOS can also include program code configured to cause the computer 102 to record, display and/or transmit messages related to the respective status or changes therein. The BIOS can further cause the computer 102 to perform alarm functions in response to a missing (disconnected) cash drawer 140, a tray that remains open beyond a permissible time period, and so on. The BIOS 112 can also include program code configured to establish cash drawer 140 access protocols, time scheduling, local or remote management functions, and so on.

### Illustrative Circuitry

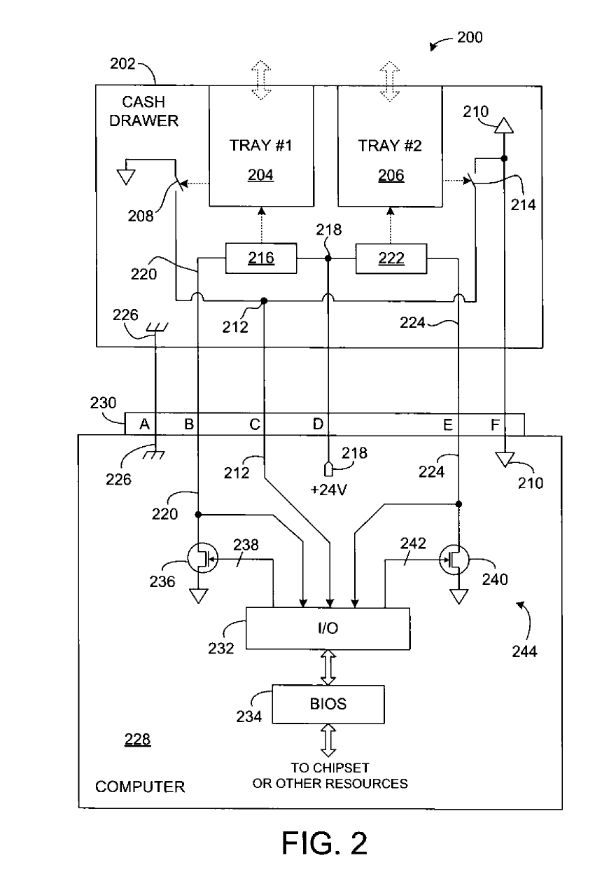

Reference is made now to FIG. 2, which depicts an arrangement 200 including elements and circuitry according to the present teachings. The arrangement 200 and particular elements thereof are illustrative and non-limiting. The present teachings contemplate other systems, arrangements, circuits and respective functions.

The arrangement 200 includes a cash drawer 202. In one example, the cash drawer 202 is equivalent or analogous to the cash drawer 140. The cash drawer 202 includes a first tray 204 and a second tray 206. Each of the trays 204 and 206 is configured to support currency or other things of value therein. The trays 204 and 206 can be independently opened by way of corresponding electrical signals, and returned to a closed, secured state by manual user input (i.e., pushed shut). Content of each tray 204 and 206 is accessible to a user when open, and the content is enclosed and secure when that tray is closed.

The cash drawer includes a status switch 208 configured to provide (affect or change) an electrical signal in accordance with an open or closed condition of the tray 204. The status switch 208 is coupled to a ground node 210 and a tray status node 212. In one example, the status switch 208 is in an electrically conductive state when the tray 204 is open, and is electrically non-conductive otherwise.

The cash drawer also includes a status switch 214 configured to provide an electrical signal in accordance with an open or closed condition of the tray 206. The status switch 214 is coupled to the ground node 210 and to the tray status node 212. In one example, the status switch 214 is in an electrically conductive state when the tray 206 is open, and is electrically non-conductive otherwise. Thus, the tray status node 212 is coupled to ground potential when either tray 204 or 206 is open, or when both are open. The tray status node 212 is biased toward another voltage level or is “floating” when both trays 204 and 206 are closed.

The cash drawer 202 includes a first solenoid 216. The solenoid 216 defines at least a portion of a locking mechanism configured to secure the tray 204 in a closed condition. The solenoid 216 is also configured to release the tray 204 so as to cause (or allow) it to open in response to an electrical signal. The solenoid 216 is coupled to an operating voltage node 218 and a pulse return node (or pulse node) 220. The tray 204 opens when an electrical pulse is provided to the solenoid 216 by way of the nodes 218 and 220.

The cash drawer 202 includes a second solenoid 222. The solenoid 222 defines at least a portion of a locking mechanism configured to secure the tray 206 in a closed condition. The solenoid 222 is also configured to release the tray 206 so as open it in response to an electrical signal. The solenoid 222 is coupled to the operating voltage node 218 and a pulse return node 224. The tray 206 opens when an electrical pulse is provided to the solenoid 222 by way of the nodes 218 and 224. The cash drawer 202 also includes (or is defined by) a chassis ground node 226.

The arrangement 200 also includes a portion of a computer 228. In one example, the computer 228 is equivalent or analogous to the computer 102. The computer 228 is coupled to the cash drawer 202 by way of a connector 230. Specifically, the connector 230 has electrical contacts defining six distinct nodes “A” through “F”, corresponding to nodes 226, 220, 212, 218, 224 and 210, respectively. In one example, the connector 230 is an RJ12 type connector, as is familiar to one having ordinary skill in the telecommunications or related arts. Other suitable connectors 230 can also be used.

The computer 228 includes an input/output (I/O) 232 coupled to the cash drawer 202 by way of the connector 230. In one example, the I/O 232 is analogous to the SIO 114. The computer 228 also includes a BIOS 234 that is coupled in digital communication with the I/O 232. In one example, the BIOS 234 is analogous to the BIOS 112. The BIOS 234 includes program code to cause the computer 228 to monitor and control the cash drawer 202.

The computer 228 includes a transistor 236, configured to operate as a switch under the control of the I/O 232. The transistor 236 is configured to couple the pulse return node 220 to the ground node 210 in response to a biasing signal 238. Thus, the computer 228 can open the tray 204 by causing the I/O 232 to forward bias the transistor 236 by way of a brief electrical pulse.

The computer 228 further includes a transistor 240, configured to operate as a switch under the control of the I/O 232. The transistor 240 is configured to couple the pulse return node 224 to the ground node 210 in response to a biasing signal 242. As such, the computer 228 can open the tray 206 by causing the I/O 232 to forward bias the transistor 240 by way of a brief electrical pulse.

The computer 228 is also configured to provide operating voltage to the cash drawer 202 by way of the node 218. As depicted, the voltage at the node 218 is twenty-four volts DC. Other suitable voltages (DC or AC) can also be used. The transistors 236 and 240, and various couplings to the nodes 210, 212, 218, 220 and 224, generally define (at least in part) circuitry 244 as contemplated by the present teachings. Other suitable circuitry configurations or constituents can also be included and used.

The I/O 232 is also connected to monitor an open or closed status of the trays 204 and 206 by way signals (i.e., voltages) present at the node 212. Again, ground potential at the node 212 indicates that either tray 204 or 206 (or both) is open. The I/O 232 is further connected to monitor a connected status of the cash drawer 202 by way of signals (i.e., voltages) at the nodes 220 and 224. The voltages at the nodes 220 and 224, respectively, are (about) equal to the operating voltage at the node 218 when the cash drawer 202 is connected to the computer 228, and neither tray 204 nor tray 206 is being signaled to open.

Conversely, the voltages at the nodes 220 and 224 are floating (or approaching ground) when the cash drawer 202 is disconnected from the computer 228. The foregoing respective signals are monitored by the I/O 232 and corresponding digital information is communicated to the BIOS 234, which in turn can cause various actions by the computer 228.

### Illustrative BIOS

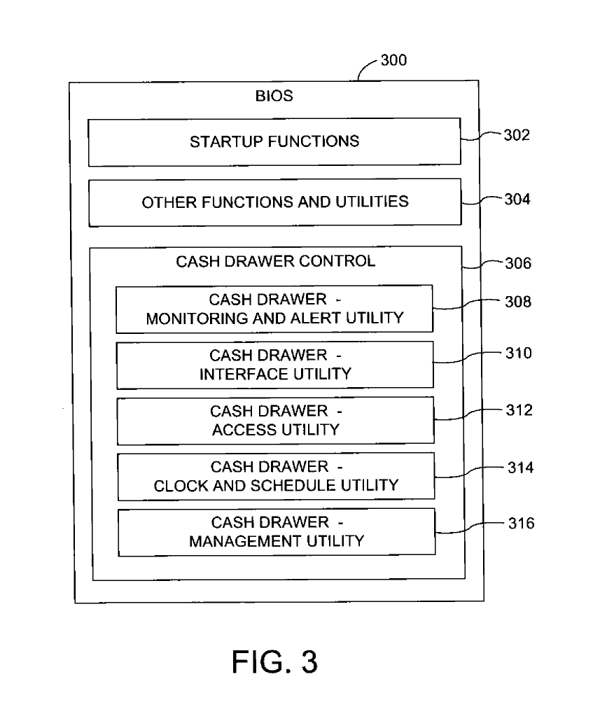

Reference is now made to FIG. 3, which depicts machine-readable (executable) program code defining a basic input-output system (BIOS) 300 in accordance with the present teachings. The BIOS 300 is illustrative and non-limiting, and the present teachings contemplate other BIOS having other respectively varying features and characteristics. The BIOS 300 is embodied by way of a solid-state storage media, a FLASH-memory integrated circuit, or other suitable machine-accessible storage.

The BIOS 300 includes startup code 302. The startup code 302 is configured to cause a processor (e.g., 104) to perform various initial operations upon power-up or another restart scenario. Thus, the startup code 302 loads appropriate values into respective registers, sets flags to respective values, directs the processor to address other program code stored elsewhere in the corresponding computer (e.g., 102), and so on. One having ordinary skill in the computer arts is familiar with startup or “boot-up” code and procedures.

The startup code 302 also sets a flag or flags such that the processor is alerted to and can access cash drawer-related program code 306 as described hereinafter. The BIOS 300 also includes other code 304 that can be configured to cause the processor to perform various other functions or utilities that are not germane to the present teachings.

The BIOS 300 also includes cash drawer control program code (drawer code) 306. The drawer code 306 is configured to cause the processor to perform respective monitoring and access control-functions over a cash drawer (e.g., 140). Illustrative examples of such access control-functions are described below.

The drawer code 306 includes a monitoring and alert utility (MA) 308. The MA utility 308 is configured to request status information regarding a cash drawer. Such status information can include a connected status of the cash drawer, an open/closed status of respective trays of the cash drawer, and so on. The MA utility 308 is also configured to issue control commands so as to open a tray or trays of the cash drawer. The MA utility 308 is further configured to record changes in cash drawer or tray status, issue message or alarms in the event that a cash drawer becomes disconnected or a tray remains open beyond a watchdog time period, provide status information on a computer display, and other functions.

The drawer code 306 includes a graphic user interface (GUI) utility 310. The GUI utility 310 is configured to present a graphical control panel or display to a user by way of a computer monitor. The graphical control panel can display respective soft-switches, user-configurable time-of-day access tables, day-of-week or holiday access tables, user-settable access passwords, and so on. The GUI utility 310 can also present status information regarding the cash drawer, the open/closed state of associated trays, and so on. The GUI utility 310 is therefore generally configured to provide a familiar, graphically-based context in which a user can establish, monitor, or change access to the associated cash drawer.

The drawer code 306 also includes an access utility 312. The access utility 312 is configured to cause the associated cash drawer to open in response to a predetermined (or reconfigurable) user input to the computer. In one example, the cash drawer is caused to open in response to a user pressing “F10” on the computer keyboard. In another example, the cash drawer opens in response to a user clicking an “OPEN” button or icon on a display screen. In yet another example, the cash drawer opens in response to a user entering a predetermined (or reconfigurable) password via the computer keyboard. The access utility 312 can be configured for other suitable access procedures, as well.

The drawer code 306 also includes a CMOS time clock utility (clock utility) 314. The clock utility 314 is configured to perform time-of-day and/or day-of-week accessibility to the cash drawer as governed by a solid-state (i.e., CMOS) clock (e.g., 122) of the computer. The clock utility 314 can also be configured such that a user can set (or reset) the solid-state clock by way of password access, an electronic key, or other security protocol.

For example, a user establishes a time-of-day access schedule for the cash drawer by way of the GUI utility 310, which is then made effective once the reconfiguration is complete. The clock utility 314 then causes the processor to allow (or deny) access to the cash drawer in accordance with the access schedule and as governed by time kept by the solid-state clock. To illustrate, if the time-of-day schedule forbids cash drawer access after 6:00 PM, and the solid-state clock has the present time at 9:14 PM, then the cash drawer remains locked and inaccessible.

The drawer code 306 also includes a management utility 316. The management utility 316 is configured such that a user can monitor or reconfigure access to the cash drawer by way of remote device (e.g., 138). The management utility 316 thus provides for access to the computer connected to the cash drawer by way of Internet-based communication. The management utility 316 can include password or encryption key-based security protocol, a GUI interface encoded for Internet-based communication to a remote user, and so on. A remote user can reconfigure time-of-day access scheduling, reset passwords, enable or disable access by respective local users (e.g., employees), and so on, by way of the management utility 316.

The drawer code 306 can further includes other utilities. Such other utilities can provide additional management or security-related functions directed to monitoring of or controlled access to the cash drawer. Such other utilities can include, without limitation, identifying authorized cash drawer users, defining their respective passwords, hand-shake protocols for associating or validating electronic keys, and so on.

### Illustrative Method

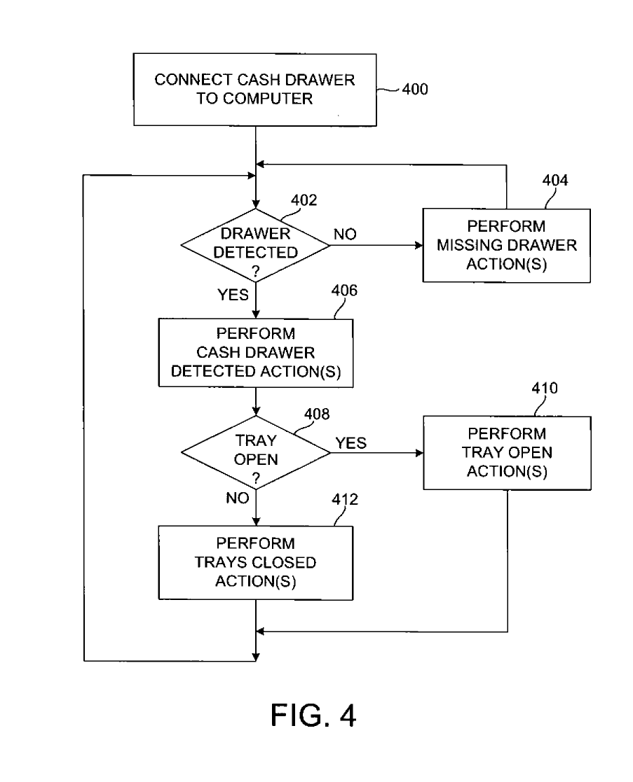

Attention is directed now to FIG. 4, which depicts a flow diagram of a method according to the present teachings. The method of FIG. 4 includes particular steps performed in a specific order of execution. However, other methods including other steps, omitting one or more of the depicted steps, or proceeding in other orders of execution, can also be used. Thus, the method of FIG. 4 is illustrative and non-limiting with respect to the present teachings. Reference is also made to FIGS. 1 and 2 in the interest of illustrating the method of FIG. 4. The method of FIG. 4 is performed by a computer in accordance with program code of a BIOS.

At 400, a cash drawer is connected to a computer. For purposes of a present example, a cash drawer 140 is coupled to a computer 102 by way of a connector 118.

At 402, it is determined if the cash drawer is detected by the computer. In the present example, voltage signals are sensed at nodes 220 and 224. If either signal (or both) is not at (about) operating voltage, or is floating, the cash drawer 140 is determined to be disconnected and the method proceeds to step 404. If both signals are at (about) operating voltage, the cash drawer 140 is determined to be connected and the method proceeds to step 406.

At 404, one or more missing cash drawer-actions are performed. For purpose of the present example, a flag within a register of the processor 104 is set to indicate a missing (disconnected) cash drawer 140. In turn, the setting of the flag can trigger recording the missing cash drawer event, transmission of a corresponding alert message, issuing a visual and/or audible alarm, or other actions. The method then returns to step 402 above.

At 406, one or more detected cash drawer-actions are performed. For purpose of the present example, a flag within a register of the processor 104 is set to indicate that the cash drawer 140 is detected. In turn, the setting of the flag can trigger recording of the detected cash drawer event, transmission of a corresponding status message, issuing a visual indication or verification, or other actions.

At 408, it is determined if any tray of the cash drawer is/are open. In the present example, the voltage signal is sensed at node 212. If the signal is at (about) ground potential, it is determined that at least one of the trays 204 or 206 is open and the method proceeds to step 410. If the signal is greater than (about) ground potential, or is floating, it is determined that both of the trays 204 and 206 are closed and the method proceeds to step 412.

At 410, one or more tray open-actions are performed. For purpose of the present example, a flag within a register of the processor 104 is set to indicate that at least one tray 204 or 206 is open. Additionally, a watchdog timing function is initiated. If such time period expires (e.g., 2 minutes) while the tray or trays remain open, an alarm or alert messaging is/are triggered. The tray open event can also be recorded. Other suitable actions can also be taken in response to the open tray detection. The method then returns to step 402 above.

At 412, one or more closed tray-actions are performed. For purpose of the present example, a flag within a register of the processor 104 is set to indicate that both trays 204 and 206 are closed. In turn, the setting of the flag can trigger recording the closed tray(s) event, transmission of a corresponding status message, issuing a visual indication or verification, or other actions. The method then returns to step 402 above.

The method described above is illustrative of any number of suitable actions that can be performed in response to detecting a present (or absent) cash drawer, and an open (or closed) state of the tray or trays of that cash drawer. Messaging, event recording (i.e., audit trail), alarm sounding, visual verifications and other suitable actions can be performed, accordingly. A local user, as well as a user of a remote device (e.g., 138), can be kept aware of cash drawer status and changes in respective status, accordingly.

In general, and without limitation, the present teachings contemplate any number of devices, systems and methods directed to computer-based cash drawer monitoring and alerting. A BIOS includes program code to cause a computer to monitoring respective states of a cash drawer and its trays and to perform various actions in response there to. Such actions can include, but are not limited to, recording events or changes in status, displaying or transmitting messages corresponding to detected states, triggering visual or audible alarms, and so on.

Circuitry and elements thereof couples signaling nodes of the cash drawer to an input/output device of the computer. The input/output device communicates status information to and receives commands from the BIOS by way of digital signaling (i.e., bytes or words). Trays of the cash drawer can be opened by way of electrical signaling from the computer, and the open/closed state of the drawers can be monitored accordingly. The BIOS includes program code directed to causing the computer to perform various functions in response to the detected cash drawer states.

The BIOS can also include program code directed local user access of the cash drawer, time-of-day scheduling, password or electronic key management, and so on. Remote management of cash drawer access procedures and security settings can also be performed in accordance with program code of the BIOS. Other cash drawer-based utilities and features can also be implemented by way of the BIOS.

In general, the foregoing description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

What is claimed is:

1. A system including a computer, the computer comprising:
circuitry to receive status signals corresponding to respective conditions of a cash drawer coupled to the computer, the circuitry to provide a control signal for opening a tray of the cash drawer; and
a solid-state storage media including a computer code defining a basic input-output system (BIOS), the BIOS to cause the computer to monitor conditions of the cash drawer by way of the status signals.

2. The system according to claim 1, the circuitry such that one of the status signals corresponds to a connected state of the cash drawer to the computer.

3. The system according to claim 1, the circuitry such that one of the status signals corresponds to an open status of the tray.

4. The system according to claim 1, the computer to provide operating power to the cash drawer by way of the circuitry.

5. The system according to claim 1, the circuitry such that the control signal is an electrical pulse.

6. The system according to claim 1, the BIOS to cause the computer to control the circuitry so as to open the tray by way of the control signal.

7. The system according to claim 1, the system further comprising the cash drawer, the cash drawer coupled to the computer by way of a connector.

8. The system according to claim 1, the circuitry including a switching element to electrically couple a pulse node to a ground node during the opening of the tray.

9. The system according to claim 1, the circuitry to couple a chassis ground node and an electrical ground node and an operating voltage node to the cash drawer, the circuitry to couple at least one pulse node and a tray status node from the cash drawer.

10. The system according to claim 1 further comprising an input/output device coupled to the circuitry, the input/output device to communicate digital information with the BIOS in accordance with the status signals and the control signal.

11. A cash drawer, comprising:
a tray to support at least currency;
a locking mechanism to open the tray in response to an electrical pulse;
a status switch to provide a signal corresponding to an open or closed state of the tray; and
cabling to electrically couple the cash drawer to a computer by way of a connector.

12. The cash drawer according to claim 11, the connector defined by an RJ12 connector.

13. The cash drawer according to claim 11, the cash drawer to receive operating voltage and electrical ground from the computer by way of the connector.

14. The cash drawer according to claim 11, the cash drawer to receive the electrical pulse from the computer by way of the connector.

15. The cash drawer according to claim 11, the cash drawer not including a key-based manually-actuated locking mechanism.

16. A computer-readable storage media, comprising:
a program code defining a basic input-output system (BIOS) for a computer, the BIOS to cause the computer to monitor a connected state of a cash drawer to the computer and to perform a first action accordingly, the BIOS to cause the computer to monitor an open state of a tray of the cash drawer and to perform a second action accordingly.
